(19) United States
(12) Patent Application Publication
(10) Pub. No.: US 2025/0001853 A1
(43) Pub. Date: Jan. 2, 2025

(54) MODULAR MOBILE WORK APPARATUS

(71) Applicant: Hudson Delta B.V., 's-Heer Arendskerke (NL)

(72) Inventor: Leendert Wilhelmus Cornelis Huissoon, 's-Heer Arendskerke (NL)

(73) Assignee: Hudson Delta B.V., 's-Heer Arendskerke (NL)

(21) Appl. No.: 18/704,648

(22) PCT Filed: Oct. 25, 2022
(86) PCT No.: PCT/EP2022/079799

§ 371 Date: Apr. 25, 2024

(30) Foreign Application Priority Data
Oct. 26, 2021 (NL) 2029510

(51) Int. Cl. B60K 1/04; B60K 17/28; E02F 9/20

(52) U.S. Cl. CPC B60K 1/04; B60K 17/28; E02F 9/207; B60K 2001/0405; B60Y 2200/41

(57) ABSTRACT

A mobile apparatus includes a main-frame with displacing means configured to displace the mobile apparatus, a rotating sub-frame rotatably connected to the main-frame such that the sub-frame is rotatable relative to the main frame and a working arm connected to the sub-frame. The main-frame and/or the sub-frame includes a plurality of modules respectively including energy storage means configured for storing energy, energy transformation means for transforming energy to electrical energy, and power train means for driving the displacing means. The modules are connectable through any one of a high voltage, low voltage or bus control system or a combination thereof and the modules are removably mountable.

### FIELD OF THE INVENTION

The present invention relates to electrified mobile apparatus with displacement means having an operating arm, such as for instance wheel loaders, front loaders on tractors, tracked loaders, skid-steers, excavators, backhoe loaders, cranes, rotating telescopic handlers, boom mowers, mobile manipulators and mobile robots or combinations thereof. The invention relates more specifically to a mobile apparatus comprising a main frame, a rotating sub-frame having an operating arm connected to the sub-frame, drive means configured to drive displacing means of the mobile apparatus, such as one or more wheels and/or one or more caterpillar tracks and energy storage with a specific topology and packaging design for both the main and sub-frame.

### BACKGROUND

Excavators, cranes, rotating telescopic handlers and boom mowers, according to the prior art, have component topology architecture and control systems originating from the era of combustion engines and hydraulics. The present invention is distinguished from this prior art (also the prior art of the inventor) in that it allows for renewable energy, electricity from batteries or hydrogen. As the energy density of batteries and of hydrogen is lower than that of fossil fuels, a new approach to a machine platform is required to allow for high performance work operations and minimize energy consumption by increasing efficiencies of all main and peripheral systems. At the same time maintenance and exchange of the various electrified components requires attention. Safety measures for batteries and hydrogen storage add complexity.

### SUMMARY

The object of embodiments of the invention is to address the above problems.

According to a first aspect, there is provided a mobile apparatus which comprises a main-frame with displacing means configured to displace the mobile apparatus, a rotating sub-frame rotatably connected to the main-frame, such that the sub-frame is rotatable relative to the main frame, a working arm connected to the sub-frame, wherein the main-frame and/or the sub-frame comprises a plurality of modules respectively comprising energy storage means configured for storing energy; energy transformation means for transforming energy to electrical energy; power train means for driving the displacing means; wherein the modules are connectable through any one of a high voltage, low voltage or bus control system or a combination thereof and wherein the modules are removably mountable. The central wiring harness allows to efficiently distribute high voltage and/or low voltage electrical power. It can be connected to different modules of which at least one of the modules has a controller, an electronic control unit, ECU, or a printed circuit board, PCB, to control and run the module and its subsystems and components. The central wiring harness can also transfer electronic signals such as for instance can-bus data for at least a module with an energy storage or a fuel cell or an electrical motor or a steering system or a braking system or a hydraulic system or a human machine interface or operating instruments, or lights, or thermal system and cooling circuits or a combination.

One or more energy storage devices such as batteries, capacitors, hydrogen tanks or tanks for solid, liquid or gaseous energy or fuel carrying capacity with related components such as for instance power electronics, inverter or converter or controllers or ECU or PCB or heating and cooling circuits can be comprised in a single module. The module can be connected to the left, right, top or bottom side of the main frame or for instance in between the displacing means or to the left, right, rear, front side, top or bottom of the sub-frame. The energy storage devices can be located with a safety distance of at least 10 cm from the outer side of the sub-frame, preferably at least 20 cm, preferably at least 30 cm, preferably at least 40 cm most preferably at least 50 cm.

Energy conversion devices such as a hydrogen fuel cell with related components such as for instance power electronics or converters or inverters or controllers or at least one ECU or PCB or gas or air pumps or compressors can be housed in the same module. Same accounts for hydrogen molecule storage in solid, liquid or gaseous, or other state or form or other gaseous or liquid energy, wherein the single module can be connected to the left, right, top or bottom side of the main frame for instance in between the displacing means or to the left, right, rear, front side, top or bottom of the sub-frame. It is also possible to install a hydrogen chemical conversion system, which can change or extract hydrogen molecules from one state to the other. An energy conversion unit such as a fuel cell does work best with small accelerations. Therefore the best location is to position a fuel cell as close as possible to the axis between the main-frame and the sub-frame to reduce accelerations in all directions, especially during rotation of the sub-frame.

One or more electric motors are ideally placed in between the left and right front displacing means or in between the left and right rear displacing means or more in between the front and rear displacing means. They can have transmissions and power electronics such as an inverter or converter or controller or ECU or PCB and a cooling and heating circuit. For maintenance reasons they are best mountable or de-mountable from the top or the bottom of the main frame through one or more openings in the main frame.

Electric motors for one or more hydraulic or pneumatic pumps or compressors or one or more power take off shafts are well positioned in front or rear of the main-frame, optionally with a transmission. Power electronics such as an inverter or converter or ECU or controller or PCB or wiring harness for them are best connected to one of the central wiring harnesses for electronic signals.

For installation and maintenance reasons, an electric motor for a Power Take Off shaft comprises of an inverter and/or a converter and/or a controller and/or a ECU and/or PCB and/or a transmission and/or a heating and/or cooling system in a single module. The single module can be connected to the left, right, top or bottom side of the main frame, preferably in between the displacing means, optionally wherein a PTO shaft runs from the front to the rear of the main-frame.

Also in a single module, an electric motor for a hydraulic pump comprises of an inverter and/or a converter and/or a controller and/or a ECU and/or PCB and/or a transmission and/or a heating and/or cooling system. The single module can be connected to the left, right, top or bottom side of the main frame, preferably in between the displacing means, optionally wherein the module is the same module as for the electric motor for the Power Take Off Shaft thereby at least one motor powering both one or more pumps and one or more PTO shafts.

An module for braking and/or steering and/or suspension system can comprise of en electric motor, power electronics and/or converter and/or controller and/or ECU and/or PCB. Optionally a transmission and/or heating and cooling circuit is also placed in the module. It ca include a compressor and/or fluid or hydraulic pump for the braking and/or steering system and/or suspension system with optionally accumulators and/or tanks. Such a module can be connected to the left, right, top or bottom side of the main frame, preferably in between the displacing means, and wherein the connection of the module and the mechanical electric, electronic, gaseous and liquid connectors can be rapidly locked and unlocked for a swift exchange of the module

The connections of the one or more modules, either mechanically, electrically, electronically are preferred to be rapid versions. It allows for a rapid locking and unlocking and exchange of a module, including gaseous or liquid connectors. Suspension and/or damping of a module or the components inside is a possible embodiment.

A controller or ECU or PCB per module or per component can have an address for an electronic bus protocol arranged so that exchange of the module is possible and health functions of the technical components or subsystems of the module can be read out and transferred. With the history of the health data storage inside the controller, ECU or PCB it is possible so repair and analyse the module without the module connected to the mobile apparatus.

When modules have standardized dimensions they can be changed, even with different functions, such as to exchange a battery module for a fuel cell module or vice versa. It is even possible to exchange between modules of the main-frame and modules of the sub-frame. One larger module can be replaced with two smaller modules. This works best when a controller, ECU or PCB recognizes the functionality of the module and the collaborating systems to adjust parameters, algorithms, performance or functionalities of the mobile apparatus.

One or more modules or a cabin can be connected to the main frame or the sub-frame through manually operated locks or connectors or through mechanic, electronic, electric, pneumatic, hydraulic or spring/damper force operated locks or locks operated through an explosive cartridge or a combination. An embodiment is possible where the locks can be operated remotely through a wireless or over-the-air system.

A connector and lock for a module are possible on the upper side of at least one module for connection to the upper side of the main frame, optionally with a lifting or pulling or pushing points on different sides of the module for transport or connecting and disconnecting.

A further embodiment relates to exceptional safety. One or more module locks with mechanical electric, electronic, gaseous and liquid connectors can be operated automatically based on sensor and/or camera input, detecting hazardous situations. They can be operated through a remote risk centre with people monitoring hazardous situations, or through a safety system, which uses algorithms or artificial intelligence to detect hazardous situations based on the sensor and/or camera input or geographical information or a combination. This is especially convenient in situations where high voltage batteries or fuel tanks or hydrogen tanks have caught fire and where the complete vehicle is hard to submerse in water or another liquid or foam.

It is best to place the fuses of a module or system or component in the main-frame, the sub-frame or the working arm or the cabin in easy reach. For example close to the module controller ECU or PCB in the module, optionally in the upper area of the main frame or in the lower, middle or upper area of the sub-frame.

The operator cabin requires attention. It can be positioned one side or centrally on the sub-frame. The cabin is connected to the central wiring system on the sub-frame including at least the bus control system and optionally with a heating and cooling system and through at least the low voltage system. The modular approach to the platform also works through in the cabin. A steer-by-wire and brake-by-wire system allow for fast assembly and disassembly. They can have redundancy by two bus lines connected to either one or two control systems through the slip-ring for between the main-frame and the sub-frame.

An embodiment is possible where the cabin can be moved from one position on the sub-frame to another. This can be secured through connection points on the cabin and the sub-frame and by lifting the cab using the working arm. On the working arm an attachment can be coupled for maneuvering the cabin such as a tilt-rotator in combination with a pallet fork and through lifting points on the cab.

The cabin can be transported while driving with the mobile apparatus in a low position. The working arm then helps together with an extra detachable support structure on the main frame.

The cabin can also be separated from the mobile apparatus, using the working arm and can be lifted onto the mobile apparatus. Then the cabin and mobile apparatus are connected wirelessly through the bus control system. The cabin then uses its own energy storage unit. In the cabin itself there are display means, connected with cameras on the mobile apparatus. The camera positions can be for instance all sides and corners of the mobile apparatus and even cameras on the working arm. For hazardous operations such as during floods or potential collapsing buildings, the modular approach to the machine platform creates safe operations for operators.

During long work periods, the cabin can be charged through solar panels or a wind generator. Of course then a heating or cooling system in the cabin will bring comfort. And for hazardous situation in which the mobile apparatus requires travelling, also the cabin can be propelled under its own power. The cabin then has its own displacement means such as wheels or caterpillar tracks. The cabin travel direction can be controlled from the operator instruments in the cabin or controlled wirelessly and remotely by a control centre outside the cabin and with the aid of images and videos from one or multiple cameras on the cabin.

An important energy consumer is the operator cabin. In the winter it requires heating and in the summer cooling. Other important power train components such as batteries, capacitors, fuel cells, inverters, electric motors, converters, even controllers and also hydraulic circuits require heating and cooling. An efficient system uses and controls this the best possible way to reduce energy consumption.

Therefore part of the modular machine platform describes a thought through thermal system, comprising of at least one coolant/heating fluid tank, one pump and a set of valves controlled by a controller, connected to the bus-system. The set of valves are connected to the following cooling/heating circuits: cabin, chiller (AC), cool/heat exchanger(s), inverter(s), electric motor(s) and at least one converter and/or a charger and/or an electric heater if part of the systems and modules. The set of valves are connected to cooling/heating circuits and preferably a heat-pump. This heat pump can also be reversed so as to function as a chiller or air conditioning or air cooler or water or fluid cooler.

The thermal system set of valves can be connected to a cooling/heating circuit of at least one hydrogen fuel cell and even to the cooling/heating circuit of a hydraulic circuit.

In order to extend the life of batteries, it is important to keep them at the best operating temperature range and thus they require cooling and heating. To achieve this, the at least one fluid pump and set of valves direct the right amount of cooling and heating fluid to the batteries and/or to capacitors. Excess heat from various power train components can be used to heat up other power train components. For instance heat from a fuel cell can be used to increase the temperature of batteries and/or capacitors and/or the cabin and/or the hydraulic fluid at low ambient temperatures. The same accounts for a charger, inverter, electric motor or transmission at low ambient. The control system receives temperature input from the separate power train components, preferably over a bus system. Then that information is used to control the valves. Again, to capture heat and divide it over components that can use it. At high ambient temperatures, many components require cooling. The control system with a controller or ECU, again, measures and directs through the valves. One or more radiators then can be used, either with or without a fan.

The cooling circuits can be kept within the sub-frame, but also from the sub-frame to the main-frame. It is preferred to have the radiators, chillers or other heat exchanger type of components working with ambient air-flow, to position them in the sub-frame. First reason is that there will be less dust and second the most undisturbed air-flow while driving at higher speeds is at the sub-frame level. The coolant/heating fluid tank is also preferred to be at a higher position on the sub-frame.

The thermal system set of valves can control the flow of at least one of the cooling/heating circuits from the sub-frame to the main frame and vice versa. It can be done by connecting the coolant/heating circuit in the main-frame of an energy storage (batteries and/or capacitor(s)), inverter(s) and/or converter(s), transmission(s), electric motor(s), optionally a compressor or pump or charger. A valve can be used to direct the cooling or heating fluid to a hydraulic circuit, either as part of one loop or to have a separate loop in the main-frame. To allow an unlimited rotation of the sub-frame, it is preferred to use a swivel joint. Optionally two swivel joints, one for the colder circuit and one for the heated and thus hotter circuit at higher ambient temperatures. In this way the coolant does not mix with higher temperature circuits. Also the bus-system can run through the slip ring, over which the central high voltage and central low voltage electric systems can run.

The thermal system set of valves are being controlled by the control system and it can direct heat from the hydraulic circuit(s) to the cabin and/or batteries or capacitors and/or other components. The set of valves also can contain one or more thermostatic valves, which automatically open or close at a given temperature range.

The control system can also direct cold fluid from the chiller (AC) to the cabin and batteries or capacitors and further on to other components such as inverters and electrical motors and chargers in both the sub-frame and the main-frame.

The same accounts for cooling or heating controllers of the main or central ECU's or computers. These are preferably mounted inside the cabin. The cooling/heating circuits to the cabin also cool or heat at least one of the controllers and/or ECUs.

A step further to increase efficiency and reduce energy consumption during operational periods is to use inputs by the operator of climatic and ambient conditions. This can also be in combination by extracting climatic and ambient data and forecasts from external sources such as the internet. This way the required cooling and heating capacities for each component throughout a working period of the mobile apparatus can be calculated and controlled, thereby pre-heating or pre-cooling one or multiple components, such as a battery, a capacitor, a fuel cell or a cabin or other components. It is possible to integrate this into a charging strategy for in stance overnight or during lunchtimes or idle times of the mobile machine and its operator.

Enhancements are possible through a total combined smart thermal management. The system is programmed to use historic data, together with forecasts to use the least amount of cooling and heating energy and keep the components at its most optimal temperature range. Climatic and ambient temperature data, history and forecasts, as well as charging and/or refuelling data, history and forecasts and component temperatures combined with operational and application data are used as inputs. Artificial intelligence is used to find the optimal balance for cooling and heating energy use and also to extend the lifetime of the components such as for batteries, capacitors, fuel cells, inverters, electric motors, controllers and other components.

The mobile apparatus preferably has at least three articulations. To allow the working arm to operate very close to the machine, but also to reach very far, the arm comprises of two actuators between the first articulation and second articulation. Ideally they are positioned opposite each other. In an economic embodiment, the actuators have the same dimensions and each one of the actuators uses its end of stroke, at best inward stroke, to determine the maximum rotation angle of the second articulation for that side.

To allow a compact working arm, the actuators can work and move partly inside the structure of the first articulation. Strength of the first articulation is provided with one or more internal structural plates. It is preferred to guide hoses or cables or pipes from the sub-frame to run through the inside of at least the first articulation. The same accounts for the second articulation.

To provide for a very open view for the operator, the second and third articulation are positioned low or high. To allow this, the first articulation has to rotate over a very large angle for it to also reach very far. In the rearward position, the working arm is functioning as counterweight for a load on the outer end of the arm. In the most forward position, there is no counterweight. Therefore more actuator force for the first articulation is required in the forward position than in the rearward position. A good balance is found through a kinematic system with a progressive actuator force. Linkages work together to increase the distance between the centreline of the actuator ad the swivel point of the first articulation as the first articulation moves forward. It is preferred to have the actuator for the first articulation to operate at the rear to allow better visibility for the operator. Mobile apparatus as claimed in any of the foregoing claims, wherein an actuator for the first articulation has the same dimensions as at least one actuator for the second articulation, optionally the same dimensions as two actuators for the second articulation.

To allow faster and more comfortable displacement and at the same time to reduce shocks and vibrations to most of the technical components such as batteries, capacitors, fuel cells and other, it is preferred to use suspension for forward or rearward driving. Kinetic suspensions, without a torsion bar, for passenger cars and trucks are known. This does not work for a machine with rotating sub-frame and working arm, where a stable apparatus is required. Therefore the main frame comprises of supporting structure on the outer edges of the main frame to connect to suspension units or actuators, which can be locked.

The support structures can have cross sectional frame parts with vertical or diagonal frame parts and with lower frame parts to allow space for a working arm and for better visibility. It also can be space to mount technical components at the rear of the main-frame.

The suspension unit or actuator connects the main-frame with an axle or structural suspension members. It is possible to use two actuators or two suspension units per displacement means, also in combination with a bump-stop.

The suspension units or actuators can be connected to a kinetic suspension with the possibility to lock each of the suspension units or actuators via valves for a stable mobile apparatus when parking, transporting or when working with the rotating sub-frame and working arm.

An oscillation mode is possible, comprising of locking valves to allow either the front or the rear displacement means to oscillate. A further embodiment claims a suspension mode. It comprises of locking valves and additional valves to allow suspension of either the front side or the rear side. The same is possible for a side suspension, where locking valves and additional valves allow suspension of the left or right side and the locking of the opposite side.

The kinetic suspension can also be configured to allow each of the displacement means to independently suspend through opening one set of valves and locking other sets of valves. This can be used to level the entire vehicle or control it to certain roll or pitch angles. All valves can then be locked to keep the apparatus stable at that orientation. Of course riding and working heights and roll, pitch and level control are possible by adding more or less hydraulic fluids and/or by adding more or less gas or air in other parts of the system. An embodiment is to have accumulators, also functioning as a force or spring element, connect directly to the actuator or suspension unit.

According to a preferred embodiment the valves on the suspension units or actuators are directly connected to a tank to relief pressure of fluid.

For propulsion, the main-frame can comprise of two electrical motors of which each of the electrical motors are connected to one axle or carrier of differential via a transmission. A third electrical motor can be connected to a power take off shaft for attachments via a transmission.

A propulsion embodiment is also possible where the transmissions for the axles or carriers of differentials are positioned on the opposite side of the electrical motor with a through shaft in the electrical motors. The third electrical motor also powers the PTO shaft.

For these configurations at least one hydraulic pump is positioned in between one electrical motor and the transmission for the power take off shaft.

According to another embodiment is possible with only two electrical motors, each with one transmission. The solution is configured to drive the displacement means and at the same time the power the take off shaft. A first electrical motor is connected to a first transmission and that same transmission is connected to at least one hydraulic pump, wherein that same transmission is connected to a second transmission with a second electrical motor through a connection or propel shaft. The second transmission can provide power from both electrical motors to the displacement means. Both electrical motors can provide power to the power take off shaft for attachments.

For all presented configurations, a transmission can have multiple speeds, a differential, a differential lock, a disconnect and a power take of shaft. When two transmissions work together, it can increase power, torque and speed to displacement means, to the power take off shaft for attachments and to at least one hydraulic pump.

In order to transport the mobile apparatus or in the event that the mobile apparatus is towing other machinery, devices or material, an ideal trailer is presented to extend the working and driving range without harmful emissions. The trailer can transport mobile apparatus such as vehicles, planes, boats, machines, tools, generators or other mobile devices. It can also transport materials, aggregate, building blocks, stones, bricks, soil, sand, wood, steel, solids or fluids. The key is to integrate energy storage modules in between a top structural plate and an under structural plate. It can have longitudinal or cross sectional structural members in between the top and under plate.

The energy storage modules preferably comprise batteries or capacitors or solid, liquid or gaseous fuel such as mounted in longitudinal, crosswise, diagonal or other directions. The trailer comprises of an inverter and/or converter and/or charger and/or compressor and/or pump to charge the batteries or capacitors and/or to fill the energy storage modules and/or to charge mobile apparatus or devices or refuel mobile apparatus or devices.

Necessary energy needs to be provided to the described mobile apparatus or other apparatus such as a vehicle, truck, wheel loader, front loader, tractor, skid-steer, fork-lift, excavator, backhoe loader, dozer, crane, telescopic handler, mower, forestry machine, combine, harvester, mobile manipulators and mobile robots or combinations thereof. These apparatus can have displacing means configured to displace the mobile apparatus, energy storage means configured for storing electrical or hydrogen energy, power train means for driving the displacing means, status information of the energy storage on board the mobile apparatus, wireless connection to send and receive data to and from an energy network such as electricity and/or hydrogen network. These apparatus are planned to perform work in between recharging and/or refuelling in a region, work area, work site or compound, mostly with several mobile apparatus together.

An embodiment of such apparatus can exchange data about the health status of the components of the mobile apparatus, the temperature of the components of the mobile apparatus such as a battery or a capacitor or a fuel cell or a hydrogen storage unit, the service interval of the mobile apparatus or service interval of components such as filters, or input from the operator about planning or the geographical location of at least one of the mobile apparatus relative to the one or more energy network recharging and/or refuelling geographical locations. This information can be combined with the energy storage status to plan recharging and/or refuelling.

Once more mobile apparatus are working in the same area, then at least two or more mobile apparatus are to be charged and/or refueled by the electricity and/or hydrogen network. This network uses the exchanged data from the multiple mobile apparatus to plan the most optimal charging and/or refuelling locations and times for a given work period such as during nights, lunch brakes, coffee brakes, weekends, vacations, repair periods and for instance planned idle times.

The one or more mobile apparatus are to be connected and recharged and/or refueled by an energy network connected wirelessly. The energy can be provide through electricity from a regional, national or international grid, or from hydrogen from a regional, national or international supply chain or pipeline in a solid, liquid or gaseous state. It can also come from electricity from a solar central (5001) with at least one solar panel (5002). Preferably it with have many solar panels. Further energy can be provided by electricity from a wind central (5003 and 5004) with at least one wind turbine. More wind turbines on or connected to the central are preferred. For instance a central tall one, and several smaller ones around it.

Energy can also be provided through hydrogen, generated in a solar central (5001) with at least one solar panel. The hydrogen can also come from a wind central (5003 and 5004) with at least one wind turbine. In addition energy can be used which is stored in batteries, capacitors or in hydrogen in a gaseous, liquid or solid state.

Further, empirical or non-empirical climatic data and weather forecasts (sunshine, clouds, temperature, rain, hail, snow, humidity, wind force, wind direction etcetera) can predict or forecast the available energy for a given work period. This is used to calculate the most economical charging and/or refuelling of the mobile apparatus for a given work period.

The solar and/or wind central can accommodate and store batteries or capacitors to exchange/swap the batteries or capacitors of the mobile apparatus. It can also store hydrogen in solid, liquid or gaseous state for refuelling the mobile apparatus. The structure of the central can serve as garage, depot, warehouse, work-shop, house, building, toilet, cabin, restaurant, or even a hotel. The structure can be fixed, stationary or can be a mobile unit such as an embodiment of one or more containers or even containers or units with displacing means.

According to a further aspect of the invention the energy storage of the mobile apparatus can be used as an energy buffer, for instance to store economic low priced energy and provide it back to the energy network when it can be sold for higher prices and/or to enable a lower cost energy network by spreading the available energy over the lowest amounts of energy storage units and/or energy centrals and whilst maintaining the required calculated and planned output of one or more mobile apparatus.

Preferably, one mobile apparatus charges a second or more mobile apparatus. The first mobile apparatus then divides the electrical energy from either electric energy stored in one of its energy storage units on board, and/or from the on-board conversion of hydrogen to electricity and/or from being connected to the energy network using electricity of hydrogen.

According to a further embodiment, the mobile apparatus charges a second or more mobile apparatus through charging connectors on the operating arm.

The features from the dependent claims, features of any of the independent claims and any features of other dependent claims may be combined as considered appropriate to the person of ordinary skill in the art, and not only in the particular combinations as defined by the claims.

### DESCRIPTION OF THE DRAWINGS

The accompanying drawings are used to illustrate presently preferred non-limiting exemplary embodiments of devices of the present invention. The above and other advantages of the features and objects of the present invention will become more apparent and the present invention will be better understood from the following detailed description when read in conjunction with the accompanying drawings, in which:

FIGS. 1A-1N illustrate an plurality of exemplary embodiments of a mobile apparatus comprising a plurality of modules;

FIGS. 2A-2C illustrate exemplary embodiments of a main-frame with support structures for displacement means, suspension members and suspension units;

FIGS. 3A-3K illustrate schematically exemplary embodiments of a kinetic hydraulic to be used in the mobile apparatus of FIGS. 1A-1N;

FIGS. 4A-4D illustrate an exemplary embodiment of a mobile apparatus comprising thermal modules;

FIG. 5A-5H illustrate exemplary embodiments of a working arm;

FIGS. 6A, B and C are schematic embodiments of possible power train configurations for the propulsion of displacement means and the propulsion of a Power Take Off shaft.

FIGS. 7A and 7B illustrate side views of embodiments of trailers with energy storage modules/components.

FIG. 8 illustrates a schematic top view of a work area where mobile apparatus such as vehicles and/or machinery are wirelessly connected with an electricity and/or hydrogen network for optimal planning of charging and/or refuelling. The network can be connected with a solar and/or wind energy central.

### DETAILED DESCRIPTION OF FIGURES

The description and drawings merely illustrate the principles of the present invention. It will thus be appreciated that those skilled in the art will be able to devise various arrangements that, although not explicitly described or shown herein, embody the principles of the present invention and are included within its scope. Furthermore, all examples recited herein are principally intended expressly to be only for pedagogical purposes to aid the reader in understanding the principles of the present invention and the concepts contributed by the inventor(s) to furthering the art, and are to be construed as being without limitation to such specifically recited examples and conditions. Moreover, all statements herein reciting principles, aspects, and embodiments of the present invention, as well as specific examples thereof, are intended to encompass equivalents thereof.

The functions of the various elements shown in the figures, including any functional blocks labelled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry or features embodying the principles of the present invention. Similarly, it will be appreciated that any flowcharts, flow diagrams, state transition diagrams, pseudo code, and the like represent various processes which may be substantially represented in computer readable medium and so executed by a computer.

It should be noted that the above-mentioned embodiments illustrate rather than limit the present invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim. The word “a” or “an” preceding an element does not exclude the presence of a plurality of such elements. The present invention can be implemented by means of hardware comprising several distinct elements and by means of a suitably programmed computer. In claims enumerating several means, several of these means can be embodied by one and the same item of hardware. The usage of the words “first”, “second”, “third”, etc. does not indicate any ordering or priority. These words are to be interpreted as names used for convenience.

In the present invention, expressions such as “comprise”, “include”, “have”, “may comprise”, “may include”, or “may have” indicate existence of corresponding features but do not exclude existence of additional features.

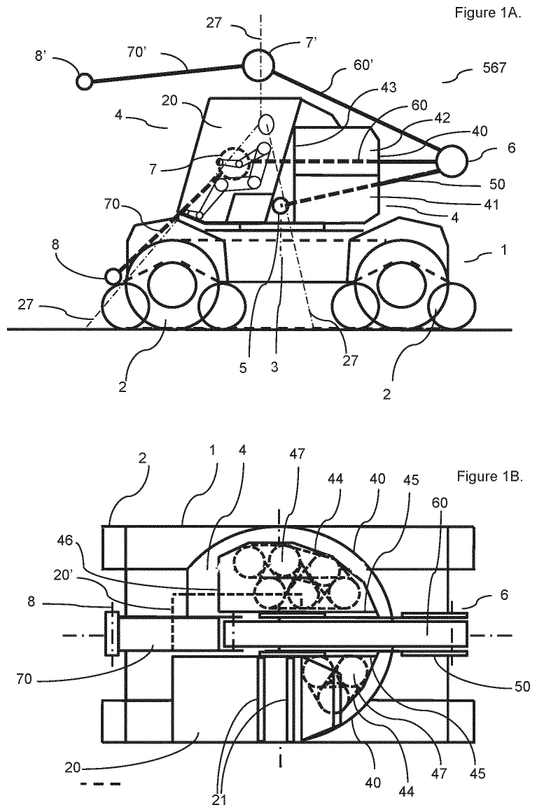

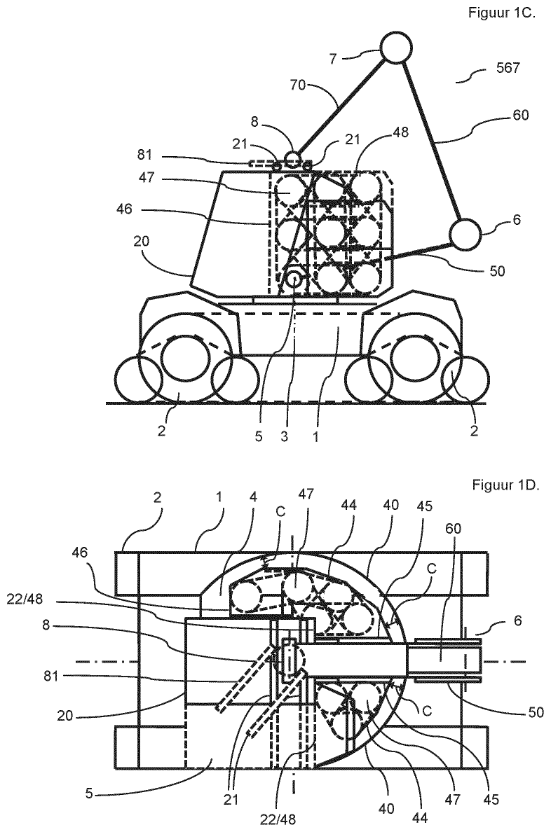

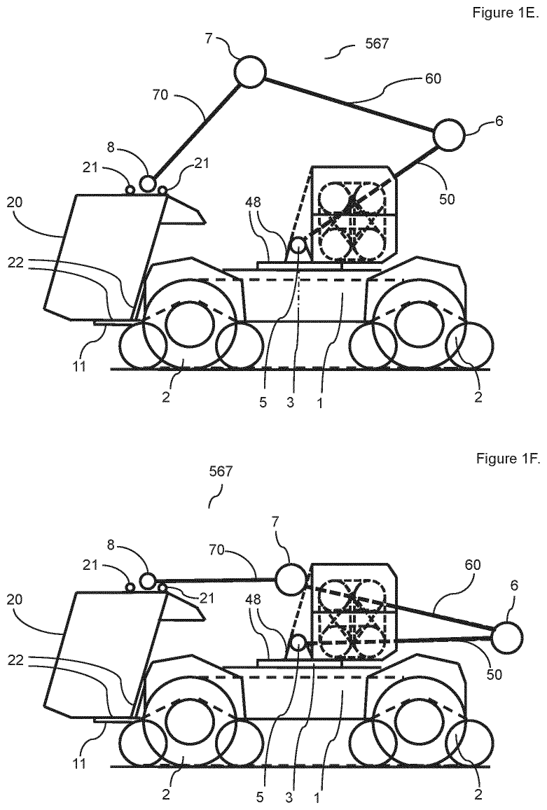

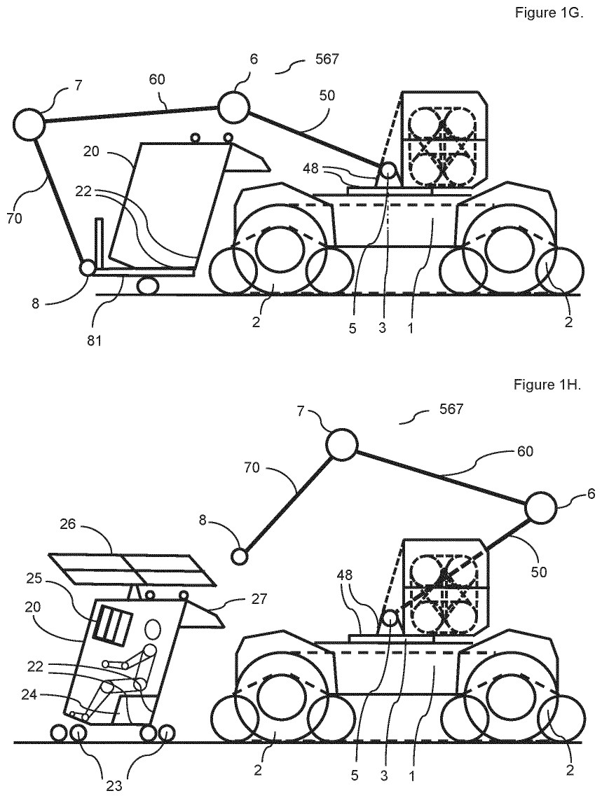

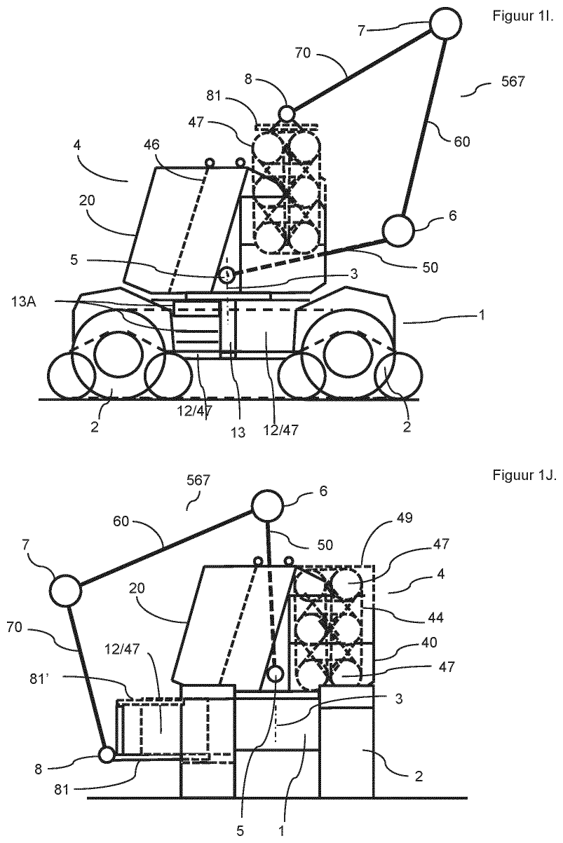

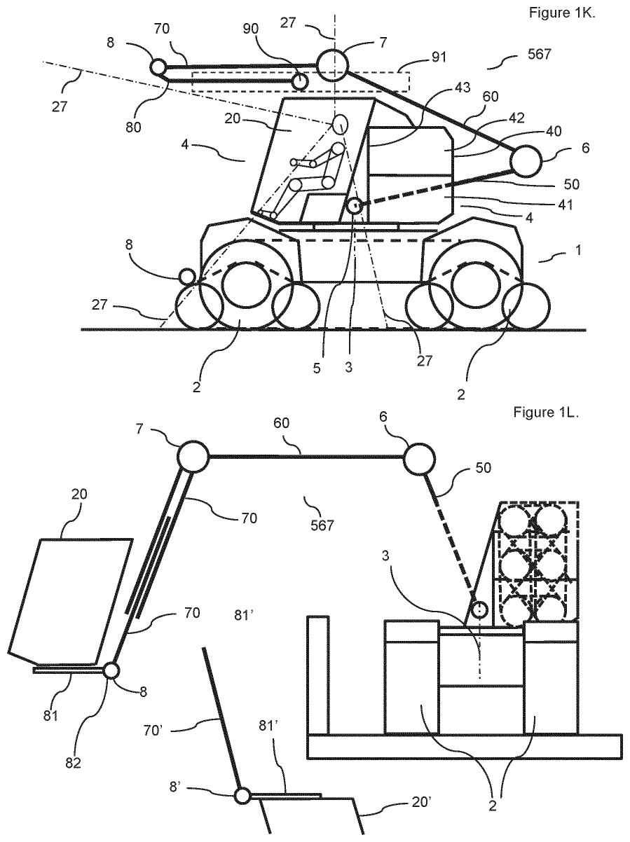

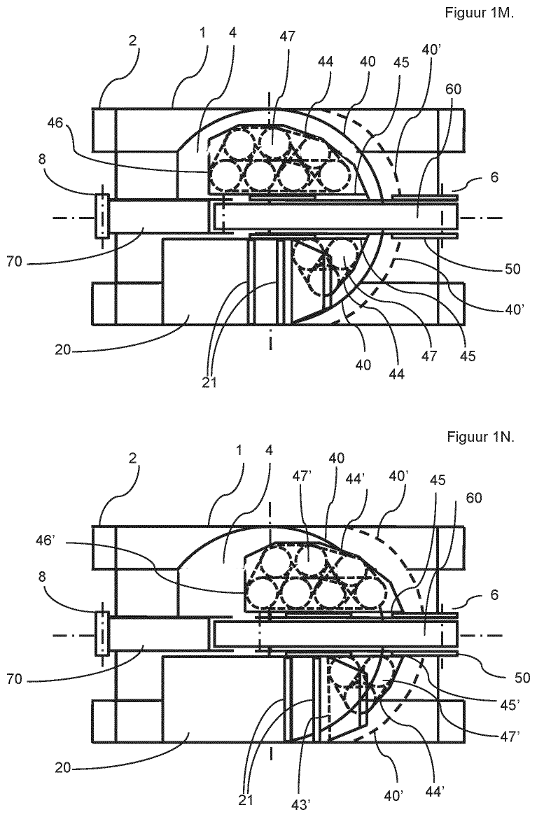

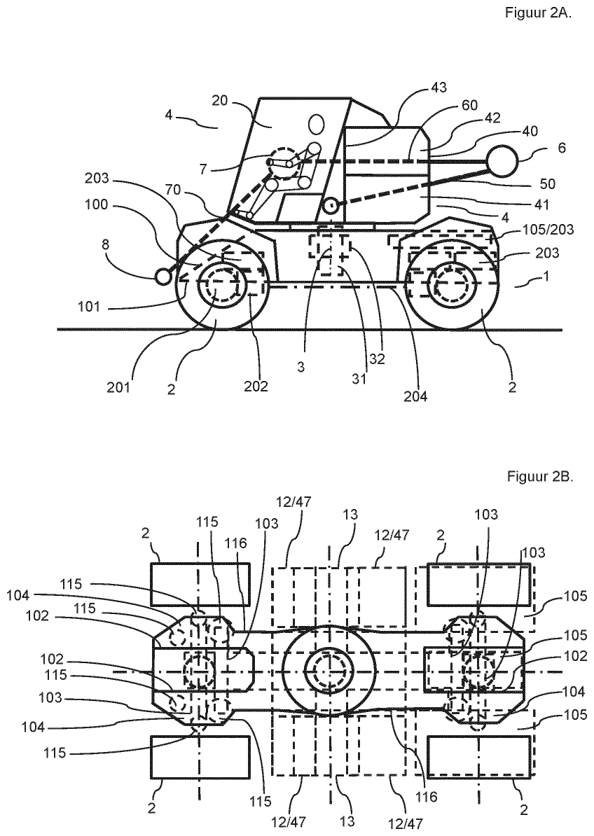

FIG. 1A illustrates a side view of an embodiment of a mobile apparatus comprising a plurality of modules. FIG. 1A illustrates in particular a mobile apparatus comprising a main frame 1. The main frame 1 has displacing means 2 configured to displace the mobile apparatus. Displacement wheels can be any one of wheels, caterpillar tracks or others. The displacement means 2 are depicted as wheels, as one caterpillar track per left side and as two caterpillar tracks per left side. The main frame 1 has a rotating sub-frame 4 connected to the main-frame 1, wherein the subframe-4 is rotatably connected to the main frame 1 such that the sub-frame 4 is rotatable relative to the main frame. The rotation axis between main-frame and sub-frame is indicated with reference number 3 in FIG. 1A.

FIG. 1A further shows that the mobile apparatus comprises a working arm 567 connected to the sub-frame 4. The working arm 567 may comprises of a plurality of articulations, preferably at least 3 articulations 50, 60, 70, for example, a first articulation 50, a second articulation 60 and a third articulation 70. Each of the articulations 50, 60, 70 may be telescopic, respectively. The working arm 567 may comprise two actuators, respectively positioned between the first articulation 50 and the second articulation 60, and the second articulation 60 and the third articulation 70. FIG. 1A shows the working arm 567 in different transport and working positions illustrated by the positions of reference numbers 6, 7, 7′, 8, 8′, for example a working position 8′, 7′ and a driving position 7 and 8. The first articulation 50, the second articulation 60 and the third articulation 70 are for this purpose rotatable with respect to each other and the sub-frame 4. Reference numbers 5, 6, 7, and 8 indicate rotation axis about which the first articulation 50, the second articulation 60 and the third articulation 70 are respectively rotatable. Rotation axis 5 lies preferably substantially horizontal and corresponds with the rotation of the first articulation 50 with respect to the sub-frame 4. Rotation axis 6 is situated between the first articulation 50 and the second articulation 60. Rotation axis 6 lies preferably substantially horizontal. Rotation axis 7, also illustrated in a second position at reference number 7′ is situated between the second articulation 60 and the third articulation 70. Rotation axis 8, also illustrated in a second position at reference number 8′, is situated between the third articulation 70 and attachment or quick coupler or tilt rotator or a fourth articulation (not shown. The rotation axis 8 can lie horizontal and/or vertical. The dotted lines 27 represent the visibility of an operator from a cab 20 situated on the main frame and are shown in relation to the working and driving positions of the working arm.

FIG. 1A shows that the sub-frame 4 comprises a plurality of modules 40, 41. Each module 40, 41 comprises at least one of an energy storage means configured for storing energy, an energy transformation means for transforming energy to electrical energy and a power train means for driving the displacing means. The modules 40, 41 are connectable through any one of a high voltage, low voltage or bus control system or a combination thereof and are removably mountable. The modules 41, 42 are in the illustrated example, arranged at the rear of the sub-frame 4. FIG. 1A shows that the modules 40, 41 are arranged in the sub-frame 4. However, the modules may also be arranged in the main frame 1 or in both the main frame and the sub-frame 4. The main-frame and/or the sub-frame 4 may comprise at least one central wiring harness comprising for the high voltage and/or low voltage electrical power which is connectable to the anyone of or a combination of the plurality of modules. In this case at least one of the modules comprises a controller configured to control and run the modules or the plurality of modules.

FIG. 1A further shows that the mobile apparatus may comprise a cabin 20 for an operator arranged on the sub-frame 4. The cabin 20 is connected to the central wiring harness including at least the bus control system and is optionally connected with a heating and cooling system through at least the low voltage system.

FIG. 1B illustrates a top view of an embodiment of a mobile apparatus with the cabin on either one side 20 or centrally positioned 20′ and the working boom 60 and 70 in between energy modules 47 and/or technical components 40, 44 and 45. Vertical wall of the sub-frame 45 can be seen on either side of the working arm.

FIG. 1C illustrates a side view of an embodiment of a mobile apparatus with the working arm 567 positioned over the sub-frame and cabin 20. It can be seen that the energy modules, e.g. batteries and/or hydrogen tanks 47 are at least in height to the top of the cabin 20, positioned vertical, horizontal or diagonal on an angle with either the vertical or the horizontal.

FIG. 1D illustrates a top view of an embodiment with distance C depicting the distance between the outer edge of rear and side(s) of sub-frame or counterweight 40 and the outer edge of energy or fuel cell module(s) or of thermal module 44, acting as a safety zone. Also in this illustration is an attachment 81 such as a pallet fork, connected to rotation axis 8, to lift, manoeuvre and/or rotate the cabin.

FIGS. 1E and 1F illustrate a preferred embodiment where a cabin 20 is lifted from the sub-frame 4 and transported on a support structure 11. Connection points 22 on the cabin and connection points on the sub-frame 48 are shown, as connection points for work arm on a cabin 21. wherein a brake-by-wire system from the cabin is connected to at least one bus line of the control system, optionally redundant with two bus lines. The cabin 20 is preferably moveable from one position on the sub-frame 4 to another. Optionally, the working arm 567 is used to pick up the cabin 20 through connection points 21 and an attachment 81 on the working arm and using connecting points 22, 48 on the cabin and sub-frame. The cabin 20 is preferably transportable while driving with the mobile apparatus in a low position using the working arm for lifting and a detachable support structure 11 on the main frame. The cabin 20 is liftable from the mobile apparatus using the working arm and is liftable onto the mobile apparatus using the working arm as is shown in FIGS. 1E and 1F.

FIG. 1D illustrates a top view of an embodiment with distance C depicting the distance between the outer edge of rear and side(s) of sub-frame or counterweight 40 and the outer edge of energy or fuel cell module(s) or of thermal module 44, acting as a safety zone. Also in this illustration is an attachment 81 such as a pallet fork, connected to rotation axis 8, to lift, manoeuvre and/or rotate the cabin. FIGS. 1E and 1F illustrate embodiments where a cabin is lifted from the sub-frame and 10 transported on a support structure 11. Connection points 22 on the cabin and connection points on the sub-frame 48 are shown, as connection points for work arm on a cabin 21. The cabin 20 and mobile apparatus are connected wirelessly through the bus control system. The cabin has a module comprising an energy storage 24, and is optionally provided with display means 25 in the cabin operably connected to cameras on the mobile apparatus such as on all sides and corners of the mobile apparatus and with cameras on the working arm.

FIG. 1G illustrates the transportation of a cabin on an attachment 81 on the working arm with displacement or support means under the attachment and/or cabin.

FIG. 1H illustrates a side view of an embodiment of the cabin disconnected from the mobile apparatus, comprising displacement means 23, which can be, for example, wheels or tracks, for displacing the cabin in a self-sufficient manner. The displacement means 23 are optionally controlled wirelessly and remotely by a control centre outside the cabin and with the aid of images and videos from one or multiple cameras on the cabin The cabin may comprise display means 25 and a solar panel 26 and/or wind generator 26 and energy storage 24 in or on the cabin.

FIG. 1I illustrates a side view of an embodiment of a mobile apparatus with a the working arm 567 lifting technical components, or technical modules or energy modules 47 from the sub-frame. It can be seen that the attachment, such as a pallet fork, 81 is rotated to lift the modules with the aid of the rotation point and axis 8. The support structure of main-frame 13 and the stairs or steps 13A for the operator on the main-frame, retractable, extendable, foldable or otherwise are shown.

FIG. 1J illustrates a front or rear view of an embodiment where the sub-frame is rotated to and the working arm can lift and/or exchange, place or replace technical components and/or energy modules 47 from and to the main-frame. Top cover of sub-frame 49 for safety features is also shown.

FIG. 1K illustrates a side view of an embodiment with a fourth articulation 80 and attachment 91 in a higher transport position to allow good visibility lines for the driver 27.

FIG. 1L illustrates a front or rear view of an embodiment with the sub-frame rotated and with a telescopic articulation 70 of a working arm connected to a cabin. It also shows an example where the cabin can be lowered by the working arm under for instance a bridge.

FIG. 1M illustrates a top view with the outer edge 40 of rear and side(s) of sub-frame or counterweight extended rearwards for a better counterweight effect.

FIG. 1N illustrates a top view of an embodiment with the outer edge or counterweight 40 and technical components and energy modules 47 extended rearwards for a better counter weight effect.

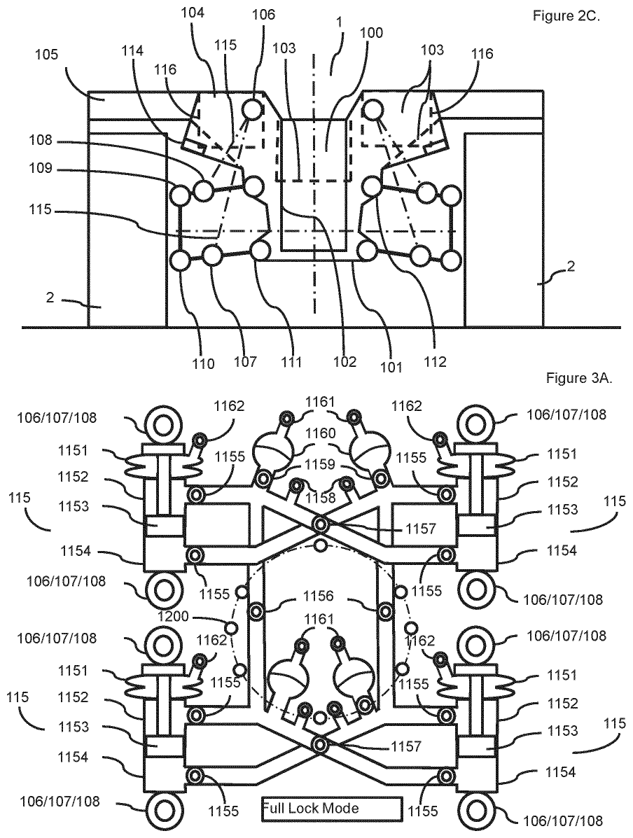

FIG. 2A illustrates a side view of an embodiment where a swivel joint 31, 32, a fluid tank 105 and power train components can be seen 202, 203.

FIG. 2B illustrates a top-view of an embodiment of a main-frame with support structures for displacement means, suspension members and suspension units, as well as space available for the working arm, technical components and energy storage energy storage units 12, 47 on either left and right side of the main frame. The support structure 13 of the main frame on the left and right side is shown. Part 102 and 103 create openings in the front and the rear of the main frame for both the working arm and technical (drive train) components.

FIG. 2C illustrates a front or rear view of an embodiment of a main-frame with locations for suspension members 115 or axles, actuators or suspension units, structural design of the main frame and space available for the working arm.

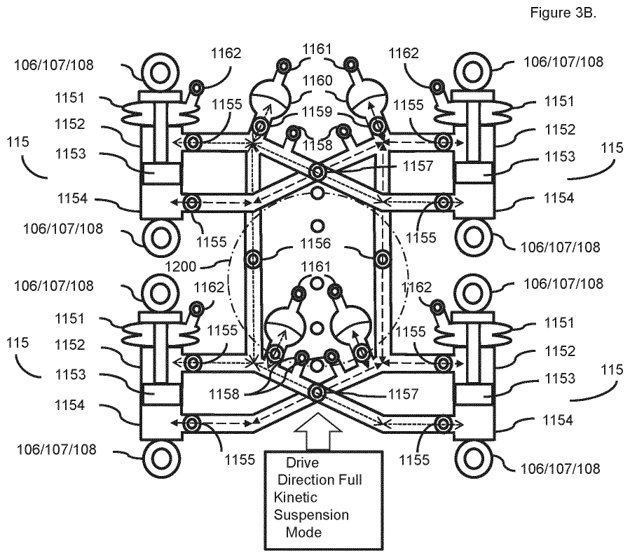

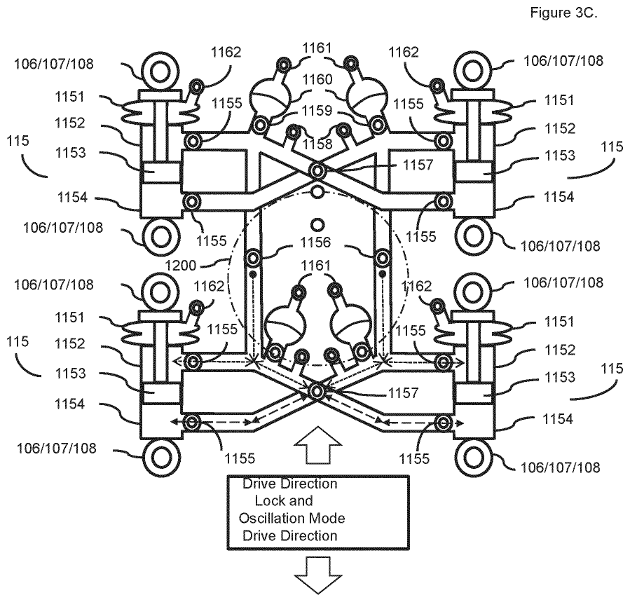

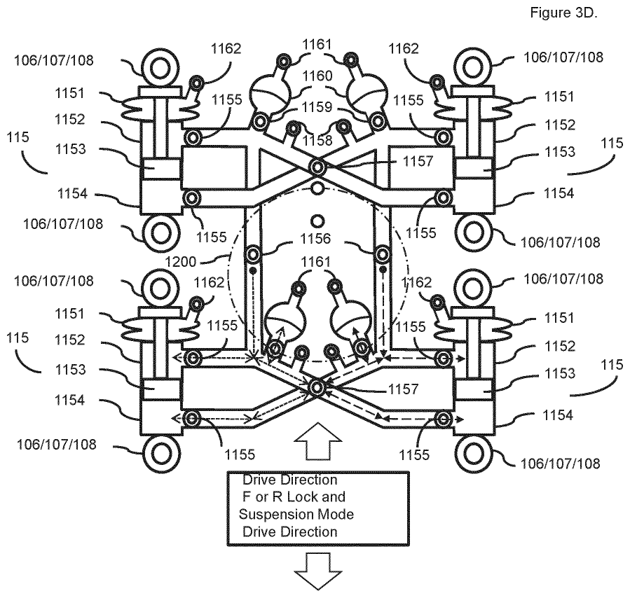

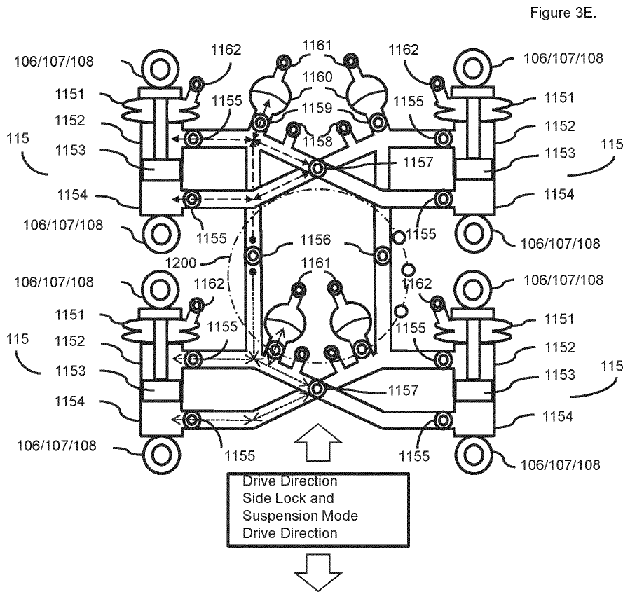

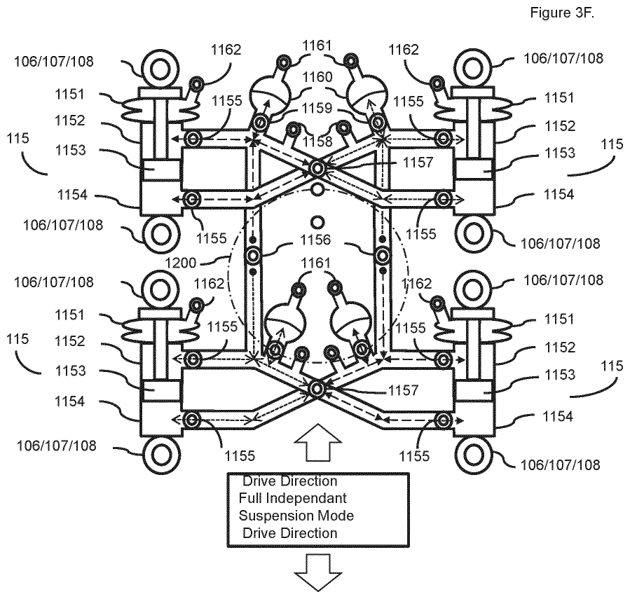

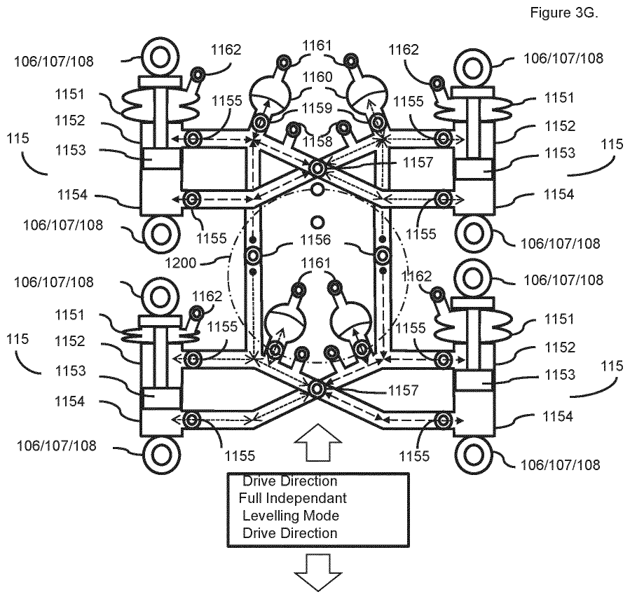

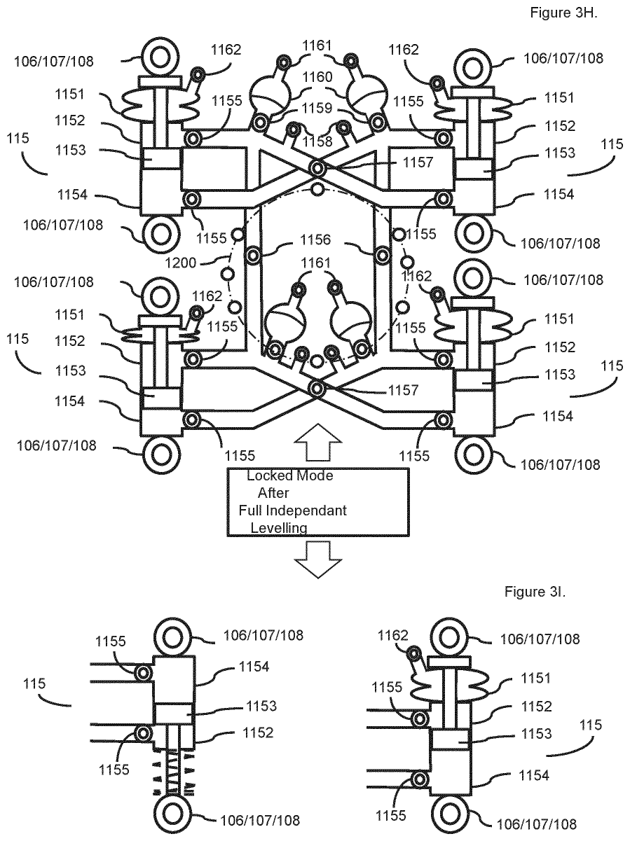

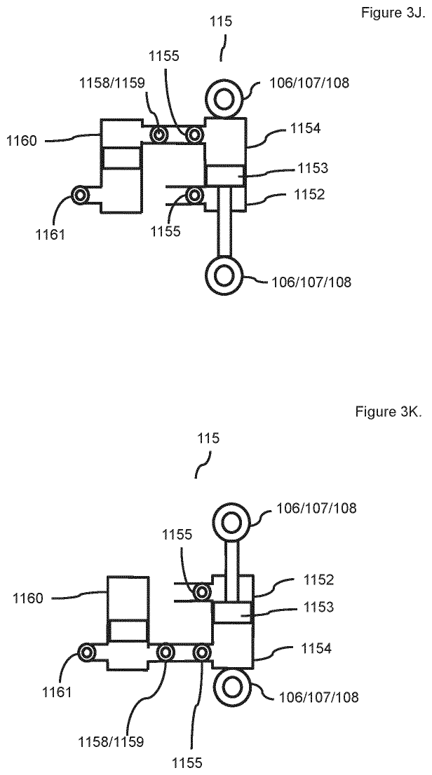

FIG. 3A illustrates schematically an embodiment of a kinetic hydraulic suspension system in a locked modus, whereby the valves 1155 on the suspension units/actuators are closed.

FIG. 3B illustrates schematically an embodiment of a kinetic suspension system, where fluid can pass through all valves 1155 on the suspension units/actuators and through valves 1156 between front and rear sections and where the front left and right are connected to the rear left and right actuators/suspension units so that rolling of the vehicle without a mechanical anti roll bar is reduced. Valves between left and right sections 1157 regulate the diagonal connections.

FIG. 3C illustrates schematically an embodiment of a kinetic suspension system, where either at the front or the rear, the valves 1155 on the suspension units/actuators and valves in between front and rear 1156 are closed and on the opposite side are open. In combination with a regulated open valve between left and right on that side the left and right displacement means can oscillate.

FIG. 3D illustrates schematically an embodiment of a kinetic suspension system, where either the front or the rear is locked through valves 1155 and 1156 and where the opposite side valves 1155 are open. On the same side valve 1157 between left and right sections is closed so that each of those displacement means can suspend independently.

FIG. 3E illustrates schematically an embodiment of a kinetic suspension system, where either the left or right side is locked through valves 1155 on the suspension units/actuators and the opposite sides are open. Valves 1157 between left and right sections are regulated so that fluid cannot pass front left to right sections, but in between the actuator/suspension units themselves. Valves between front and rear sections are closed to allow the suspended displacement means to move independently.

FIG. 3F illustrates schematically an embodiment of a kinetic suspension system in full independent suspension mode. All valves 1155 on each side of the suspension unit or actuator are open, however valves between front and rear 1156 and left and right 157 sections are closed. Each displacement means is therefore independently suspended.

FIG. 3G illustrates the suspension system in a similar independent mode, however, the suspension units or actuators 115 are controlled by adding pressure or fluid through either valves 1158 and/or 1159 and/or 1161 and/or 1162 so that the height of each of the displacement means can be controlled and as such levelling and/or roll and or pitch orientations or angles can be achieved.

FIG. 3H illustrates schematically an embodiment of a suspension where each of the suspension units or actuators 115 are locked after a levelling and/or roll and/or pitch orientation has been achieved.

FIG. 3I illustrates two embodiments of suspensions or actuators 115, either with air or a gas bellow or with a spring unit.

FIG. 3J illustrates an embodiment of a suspension or actuator unit 115 with an accumulator for example a piston, membrane, bladder or other type 1160 directly connected on the cylinder bottom side 1154, which is located on the top in this orientation.

FIG. 3K illustrates an embodiment of a suspension or actuator unit 115 with an accumulator, e.g. a piston, membrane, bladder or other type 1160 directly connected on the cylinder bottom side 1154, which is located beneath in this orientation.

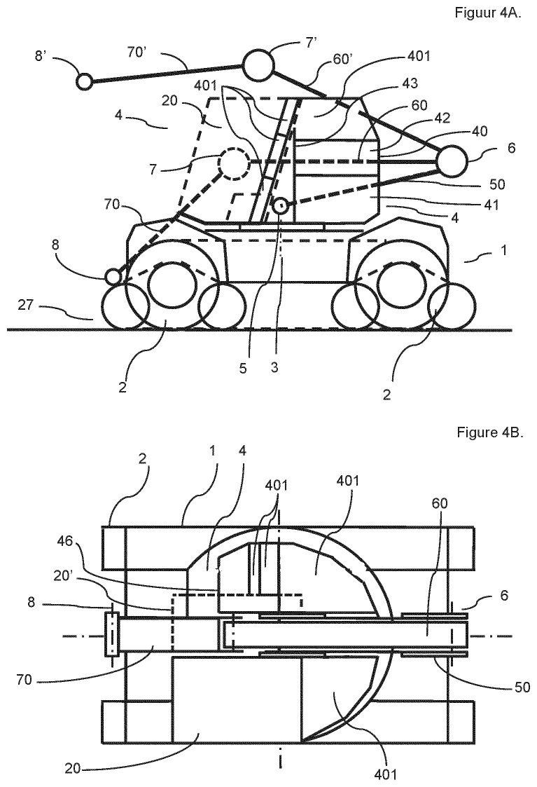

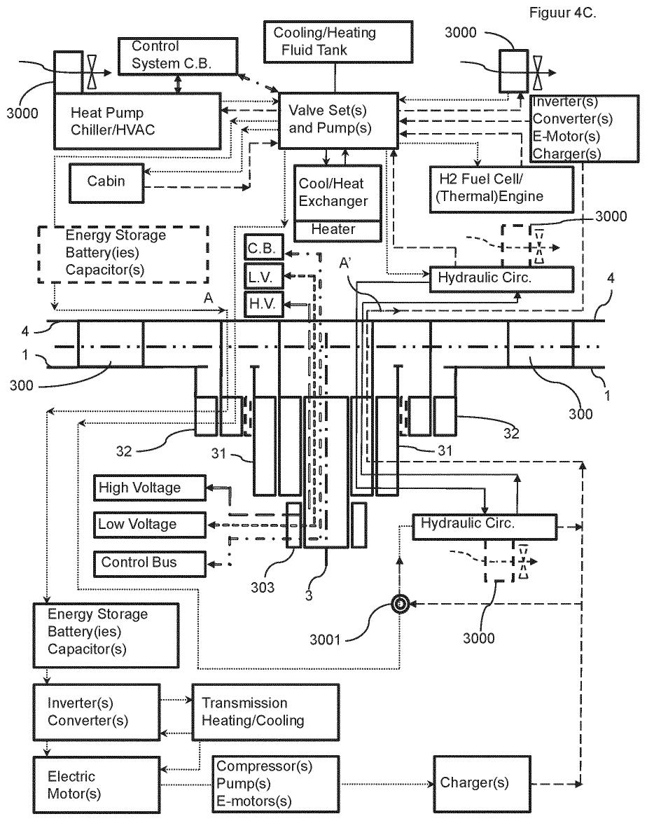

FIG. 4A illustrates a side view of an embodiment of thermal modules or components such as a chiller, evaporator, radiator, heat pump, HVAC, receiver, dryer, condenser, heater, fan, heat exchanger etc. 401 in and on the sub-frame.

FIG. 4B illustrates a side top view of an embodiment of thermal modules 401 or components such as a chiller, evaporator, radiator, heat pump, HVAC, receiver, dryer, condenser, heater, fan, heat exchanger etc. 401 in and on the sub-frame.

FIG. 4C illustrates schematically an embodiment where the central wiring harness and thermal components and circuits are connected on both the main- and sub-frame and can form connections in between. The lines and arrows illustrate how the thermal flows run from and to the different components. High voltage, low voltage electricity, control (can-bus) signals, hydraulics and thermal flows are all going through the slip ring and swivel joint. In this embodiment and illustration, the heat exchangers 3000 are positioned in the rotating sub-frame.

FIG. 4D illustrates schematically illustration of an embodiment where the central wiring harness and thermal components and circuits are connected on both the main- and sub-frame and can form connections in between. The difference between the configuration of FIG. 4C is the sequence of the components in the cool/heat circuits in the main frame and an additional heat exchanger and/or radiator. In this embodiment and illustration the heat exchangers 3000 are positioned both in the in the rotating sub-frame and the main frame.

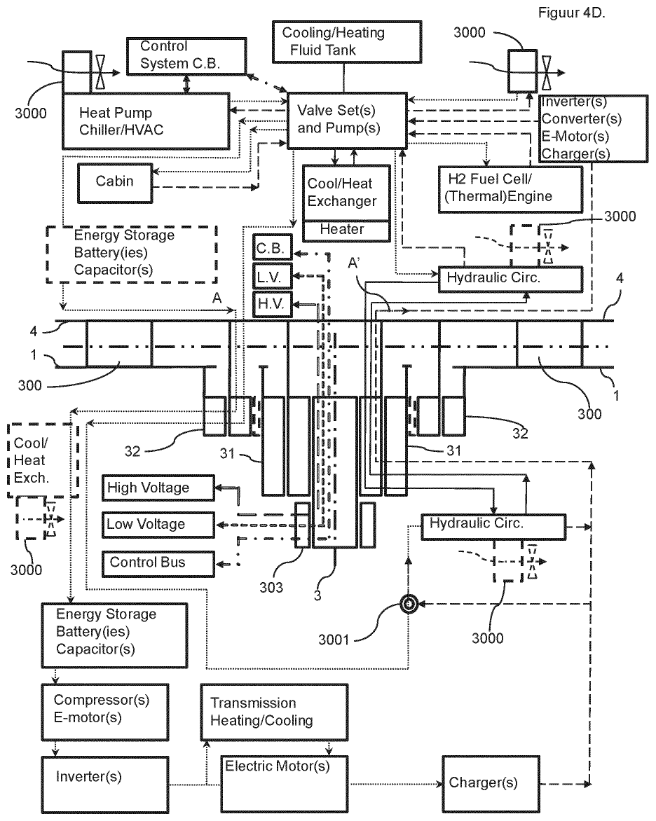

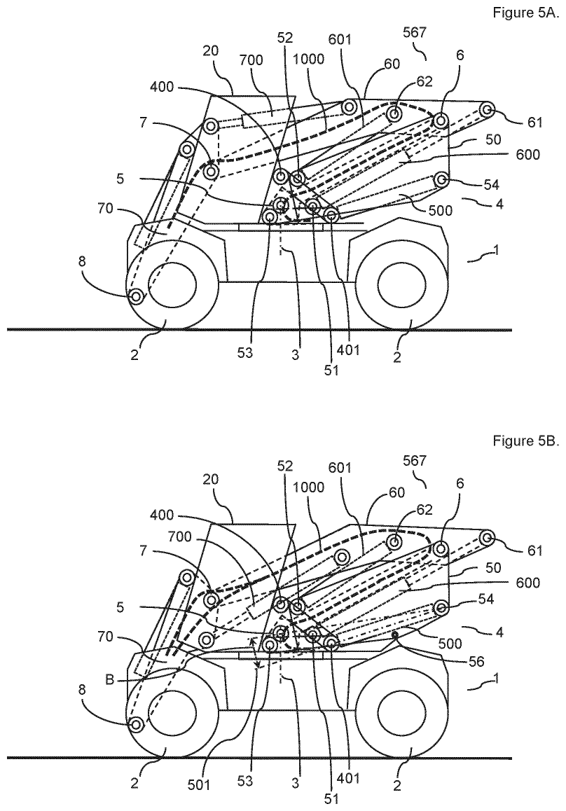

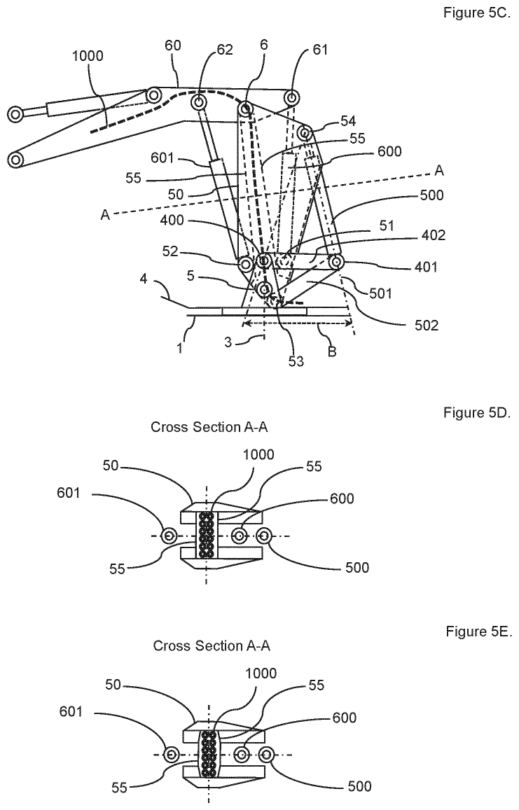

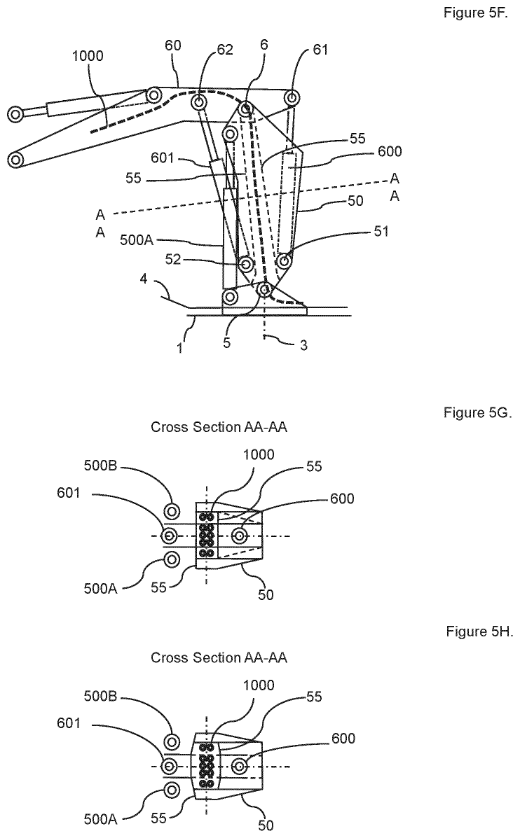

FIG. 5A illustrates a side view of a possible embodiment of a working arm 567 where the first articulation 50 is in the most rearward position.

FIG. 5B illustrates a side view of a possible embodiment of a working arm 567 where the actuator between the second 60 and third articulation 70 is positioned on the inside.

FIG. 5C illustrates a side view of a possible embodiment of a working arm 567 where a linkage between the sub-frame and the first articulation provides a large rotation angle for the first articulation.

FIGS. 5D and 5E illustrate cross sections of embodiments of the first articulation 50.

FIG. 5F illustrates a side view of a possible embodiment where at least one actuator 500A for the first articulation is positioned on the inside between the sub-frame and the first articulation.

FIGS. 5G and 5H illustrate cross sections with 2 actuators 500A, 500B for the first articulation positioned on the inside between the sub-frame and the first articulation.

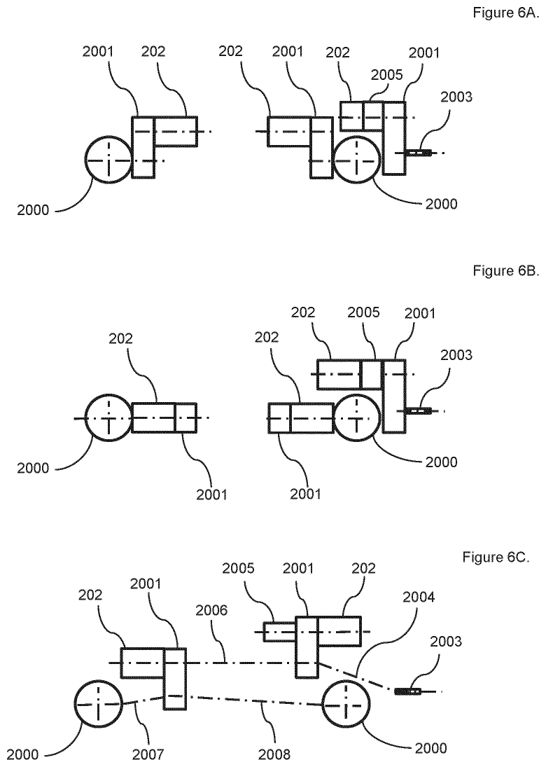

FIGS. 6A, B and C are schematic embodiments of possible power train configurations for the propulsion of displacement means and the propulsion of a Power Take Off shaft.

FIG. 6A illustrates 3 different electric motors with their transmissions combined. Two motors for the displacement means (front and rear) and one for auxiliary functions such as the hydraulics and power take off.

FIG. 6B is similar with the transmission for the displacement means in line with the electric motors and the axle/differential.

FIG. 6C shows one electric motor and a transmission, e.g. a transfer case with f.i. a central differential or disconnect, for both the front and rear displacement means or axles. This can be coupled (connected or disconnected) to a second electric motor for auxiliary functions such as the hydraulics and power take off. In such a way the power of both electric motor can be combined for each of the mentioned functions.

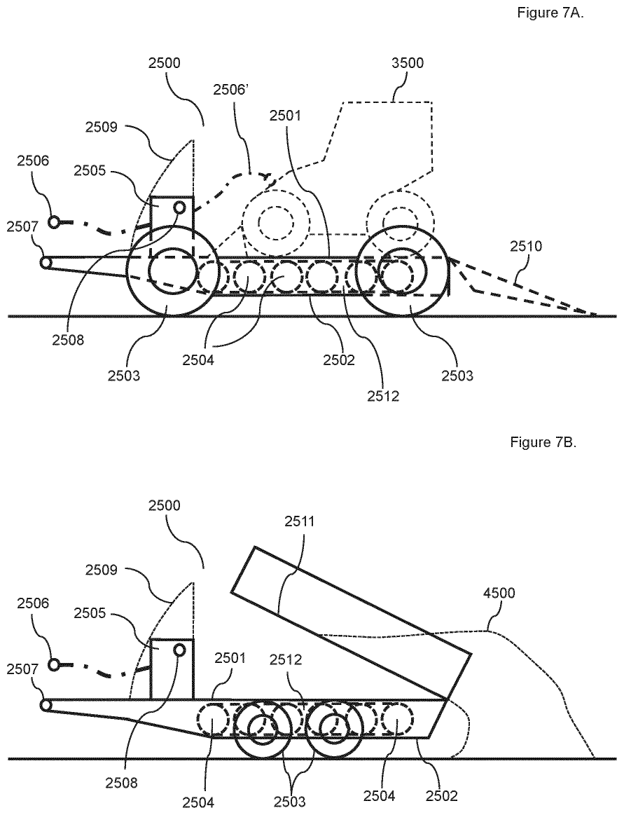

FIGS. 7A and 7B illustrate side views of embodiments of trailers with energy storage modules/components.

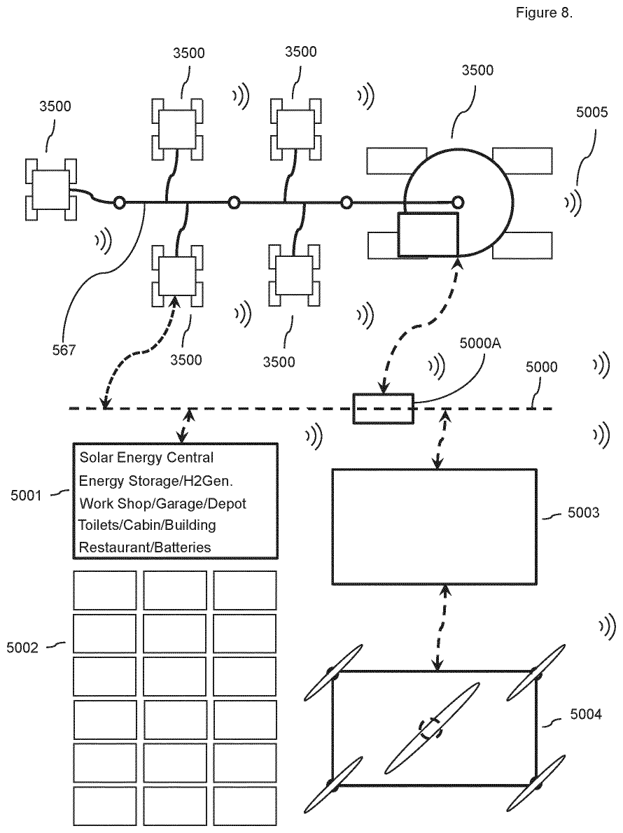

FIG. 8 illustrates a schematic top view of a work area where mobile apparatus such as vehicles and/or machinery are wirelessly connected with an electricity and/or hydrogen network for optimal planning of charging and/or refuelling. The network can be connected with a solar and/or wind energy central.

Whilst the principles of the present invention have been set out above in connection with specific embodiments, it is to be understood that this description is merely made by way of example and not as a limitation of the scope of protection which is determined by the appended claims.

### COMPONENTS

A summary of the features referred to in the figures is provided here below:
1. Main-frame
2. Displacement means (wheels, caterpillar tracks or other)
3. Rotation axis (vertical) between main-frame and sub-frame
4. Sub-frame (rotating)
5. Rotation axis (horizontal and/of vertical) of first articulation 50 and sub-frame 4
6. Rotation axis (horizontal) between first articulation 50 and second articulation 60
7/7′. Rotation axis (horizontal) between second articulation 60 and third articulation 70
8/8′. Rotation axis (horizontal and/or vertical) between third articulation 70 and attachment or quick coupler or tilt rotator or fourth articulation 80
9. Rotation axis (horizontal and/or vertical) between fourth articulation (80) and attachment or quick coupler or tilt rotator
11. Support Structure on main-frame for cabin in front for transport
12. Energy module (battery, capacitor, hydrogen, fuel, solid, gaseous, other)
13. Support structure of main-frame
13A. Stairs or steps for the operator on the main-frame, retractable, extendable, foldable or otherwise
567. Work Arm
20. Cabin
21. Connection points for work arm on cabin
22. Connection points for sub-frame on cabin
23. Displacement means for cabin (wheels, caterpillar tracks or other)
24. Energy storage for cabin (battery, capacitor, hydrogen, fuel and other) or thermal system
25. Computer screen(s) or display(s) or monitor(s) in cabin
26. Solar panels and/or wind generator
27. Sight lines for operator in cabin
31. Swivel joint for cooling and/or heating circuit(s)
32. Swivel joint for cooling and/or heating circuit(s)
40. Outer edge of rear and side(s) of sub-frame or counterweight
41/42. Energy storage module, such as battery, capacitor, tanks for solid, fluid or gaseous hydrogen, oriented vertical, horizontal, diagonal (2d/3d) or an energy conversion module such as a hydrogen fuel cell or a module for the conversion of hydrogen from solid to fluid or from solid or fluid to a gaseous state
43/43′. Vertical safety wall between cabin and energy module(s)
44. Outer edge of energy or fuel cell module(s) or of thermal module
45. Vertical wall of sub-frame
46. Vertical or diagonal safety wall on front of sub-frame
47/47′. Energy storage module, such as battery, capacitor, tanks for solid, fluid or gaseous hydrogen, oriented vertical, horizontal, diagonal (2d/3d) or generator
48. Connecting points for cabin on sub-frame
49. Top cover of sub-frame (safety feature for high pressures/explosions)
50. First articulation of working arm (optionally telescopic)
51. Attachment point of a first actuator 600 on first articulation 50
52. Attachment point of a second actuator 601 on first articulation 50
53. Attachment point of linkage 502 on first articulation 50
54. Attachment/swivel point of actuator 500 between linkages 402 and 502
55. Internal structural plate of first articulation 50, with bend or straight or other shape
56. Connection/locking point of sub-frame 4 with first articulation 50
60. Second articulation of working arm (optionally telescopic)
61. Attachment point of a first actuator 600 on second articulation 60
62. Attachment point of a second actuator 601 on second articulation 60
70. Third articulation of working arm (optionally telescopic)
80. Fourth articulation of working arm (optionally telescopic)
81. Attachment for working arm such as pallet fork
82. Camera on working boom
91. Attachment for working arm such as mower or cutter
100. Part (diagonal) of main-frame in between support structure of displacement means for space to working arm and for visibility to operator
101. Underside of main-frame structure
102. Vertical or diagonal part of main-frame in between displacement means and being part of support structure for displacement means
103. Cross section(s) of main-frame, part of support structure for displacement means
104. Support structure of main-frame for displacement means or structural members for axles or suspension for displacement means
105. Fluid tank such as for hydraulic oil
106. Attachment/swivel point of suspension structural member on main-frame
107. Attachment/swivel point of suspension unit or actuator with axle or on lower structural member of suspension
108. Attachment/swivel point of suspension unit or actuator with axle or on upper structural member of suspension
108. Attachment/swivel point of suspension structural member or axle
109. Upper attachment/swivel point of suspension structural member or axle with knuckle of displacement means
110. Lower attachment/swivel point of suspension structural member or axle with knuckle of displacement means
111. Lower attachment/swivel point of suspension structural member or axle with main-frame
112. Upper attachment/swivel point of suspension structural member or axle with main-frame
114. Bump-stop to restrict further movement of displacement means upwards to main-frame
115. Suspension unit or actuator
116. Frame part with torsion strong sections or box or other cross sectional shapes
202. Electric motor
203. Inverter or converter
204. Propel shaft
300. Slew ring/bearing
303. Slip ring
400. Attachment point of linkage 402 on sub-frame 4
401. Thermal module (chiller, evaporator, radiator, heat pump, HVAC, receiver, dryer, condenser, heater, fan, heat exchanger etc.)
402. Linkage between attachment/swivel point 400 and actuator attachment/swivel point 401
500. Actuator between attachment/swivel point 401 point and first articulation 50 and 54
502. Linkage between attachment/swivel point 53 and actuator attachment/swivel point 401
600. First actuator between first articulation 50 and second articulation (60)
601. Second actuator between first articulation 50 and second articulation (60)
700. Actuator between second articulation 60 and third articulation (70)
1000. Hoses or cables or pipes from sub-frame 4 through the inside of the articulations
1151. Gas/air bellow
1152. Cylinder rod side (hydraulic)
1153. Piston
1154. Cylinder bottom side (hydraulic)
1155. Valve open/close or proportional
1156. Valve open/close or proportional between front and rear circuits
1157. Valve open/close or proportional between left and right circuits
1158. Connection point for fluid pressure to circuit
1159. Connection point and valve in between circuit and accumulator
1160. Accumulator (piston, membrane, bladder or other type)
1161. Connection and valve for gas/air accumulator
1162. Connection and valve for gas/air pressure
1200. Centre line circle with orientation of centre point of gravity of mobile apparatus, depicted by way of small circles over the centre line circle
2000. Axle, differential or carrier with internal gears and with optional differential lock and/or with optional torque vectoring
2001. Transmission with one or multiple (2/3/4/5/6 or more or variable) speeds and/or with optional Power Take Off (PTO) possibility and/or with optional differential lock and/or with optional disconnect referred to as Transfer Case or Dropbox or Transmission
2003. Power Take Off shaft for attachments
2004. Coupling or propel shaft from transmission to Power Take Off shaft (PTO) for attachments
2005. One or more hydraulic pumps
2006. Coupling or propel shaft between one PTO output/input shaft from one transmission to one output shaft of another transmission
2007. Coupling or propel shaft from an output shaft from a transmission to an axle, differential or carrier
2008. Coupling or propel shaft from an output shaft from a transmission to an axle, differential or carrier
2500. Trailer with energy storage
2501. Top structural plate of frame of trailer
2502. Under structural plate of frame of trailer
2503. Displacement means such as wheels or caterpillar tracks or other
2504. Energy storage module(s) such as batteries, capacitors, solid, liquid or gaseous fuel for instance hydrogen or combinations mounted longitudinal, crosswise, diagonal or other directions or combinations in the form of tanks (cylindrical or box or other) or containers or compartments or box shapes or other shapes and forms of various materials
2505. Inverter and/or converter and/or charger and/or compressor and/or pump to charge the batteries or capacitors and/or to fill the energy storage modules and/or to charge mobile apparatus or devices or buildings and/or to refuel mobile apparatus or devices or buildings
2506. Charging cable or hydrogen refuel nozzle hose or other connection to transfer energy or fuel
2507. Towing point/hitch
2508. Charging or refuelling point for the energy storage of the trailer
2509. Fairing or cover to protect and/or for better aerodynamic efficiency
2510. Ramp
2511. Movable loading deck/container
2512. Longitudinal or cross sectional structural member in between top plate 2501 and under plate
3000. Radiator, optionally with (electric) fan
3001. Valve or thermostat to direct cooling/heating circuit to hydraulic circuit in main-frame
3500. Mobile apparatus (vehicle, plane, boat, machine, tool, generator or other device), wireless connected to data network
4500. Material, aggregate, building blocks, stones, bricks, soil, sand, wood, steel, solids, fluids
5000. Electricity network/grid or hydrogen refuelling lines, wireless or with wires connected to data network
5000A. Connection box for electricity or hydrogen refuelling, wireless or with wires connected to data network
5001. Solar Energy Central or building or house or container, serving as electric energy storage in batteries or capacitors or hydrogen energy storage in various forms, solid, liquid or gaseous or other and can also serve as workshop, garage, depot, toilets, restaurant, cabin, hotel, apartment, connected (wires or wirelessly) with data network
5002. Solar panel(s)
5003. Wind Energy Central or building or house or container, serving as electric energy storage in batteries or capacitors or hydrogen energy storage in various forms, solid, liquid or gaseous or other and can also serve as workshop, garage, depot, toilets, restaurant, cabin, hotel, apartment, connected (wires or wirelessly) with data network
5004. Additional Wind Energy Central 5003
5005. Device to send wirelessly data from mobile apparatus 3500 or connection box 5000A or Solar or Wind Energy Central 5001/5003) or other locations or devices or apparatus connected to the electricity/hydrogen network 5000
A. Cooling/heating circuit connected to further circuit on sub-frame A′ or to main-frame
A′. Connection of cooling or heating circuit directly from A on sub-frame
B. Distance between axis of rotation 5 of first articulation and centreline of actuator 500 of first articulation
C. Distance between the outer edge of rear and side(s) of sub-frame or counterweight 40 and the outer edge of energy or fuel cell module(s) or of thermal module 44, acting as a safety zone.
A-A. Cross section of first articulation 50
AA-AA. Cross section of first articulation 50

1-77. (canceled)

78. A mobile apparatus, comprising:
a main-frame with displacing means configured to displace the mobile apparatus;
a rotating sub-frame rotatably connected to the main-frame, such that the sub-frame is rotatable relative to the main frame; and
a working arm connected to the sub-frame,
wherein the main-frame and/or the sub-frame comprises a plurality of modules wherein each module comprises at least one of an energy storage means configured for storing energy, an energy transformation means for transforming energy to electrical energy and a power train means for driving the displacing means;
wherein the modules are connectable through any one of a high voltage, low voltage or bus control system or a combination thereof and wherein the modules are removably mountable,
wherein the main-frame and/or the sub-frame comprises at least one central wiring harness comprising for the high voltage and/or low voltage electrical power which is connectable to any one of the energy storage means, energy transformation means and power train means, wherein at least one of the modules comprises a controller configured to control and run the module, and
wherein the mobile apparatus further comprises a cabin for an operator arranged on the sub-frame wherein the cabin is connected to the central wiring harness including at least the bus control system and wherein the cabin is optionally connected with a heating and cooling system through at least the low voltage system.

79. The mobile apparatus of claim 78, wherein the energy storage of the cabin is chargeable through solar panels and/or a wind generator, optionally with a heating and cooling system in the cabin.

80. The mobile apparatus of claim 78, wherein the cabin has displacement means controllable from the operator instruments in the cabin, and wherein the displacement means are optionally controlled wirelessly and remotely by a control center outside the cabin and with the aid of images and videos from one or multiple cameras on the cabin.

81. A mobile apparatus, comprising:
a main-frame with displacing means configured to displace the mobile apparatus;
a rotating sub-frame rotatably connected to the main-frame, such that the sub-frame is rotatable relative to the main frame;
a working arm connected to the sub-frame, and
at least one module comprising a thermal management system having at least one coolant/heating fluid tank, one pump and a set of valves controlled by a controller, connected to the bus-system, wherein the set of valves are connected to the following cooling/heating circuits: cabin, chiller (AC), cool/heat exchanger(s), inverter(s), electric motor(s) and optionally at least one converter;
wherein the main-frame and/or the sub-frame comprises a plurality of modules wherein each module comprises at least one of an energy storage means configured for storing energy, an energy transformation means for transforming energy to electrical energy and a power train means for driving the displacing means; and
wherein the modules are connectable through any one of a high voltage, low voltage or bus control system or a combination thereof and wherein the modules are removably mountable.

82. The mobile apparatus of claim 81, wherein the set of valves are connected to cooling/heating circuits of a heat-pump, optionally to a cooling/heating circuit of a charger or a heater.

83. The mobile apparatus of claim 81, wherein the set of valves are connected to a cooling/heating circuit of at least one hydrogen fuel cell, optionally to a cooling/heating circuit of a hydraulic circuit.

84. The mobile apparatus of claim 81, wherein the set of valves are connected to a cooling/heating circuit of at least one energy storage module.

85. The mobile apparatus of claim 81, wherein the set of valves are connected to one or more radiators.

86. The mobile apparatus of claim 81, wherein the thermal management system controls the flow of the coolant within the sub-frame, for instance connecting a first cooling circuit to a second cooling circuit.

87. The mobile apparatus of claim 81, wherein the thermal management system controls the flow of at least one of the cooling/heating circuits from the sub-frame to the main frame and vice versa, optionally connecting the coolant/heating circuit in the main-frame of an energy storage (batteries and/or capacitor(s)), inverter(s) and/or converter(s), transmission(s), electric motor(s), optionally a compressor or pump or charger.

88. The mobile apparatus of claim 81, wherein the thermal management system controls the fluid flow of at least one of the cooling/heating circuits from the sub-frame to the main-frame, wherein, optionally, the hydraulic circuit in the main-frame are heated or cooled from one combined cooling/heating circuit with other components or from a separate circuit, optionally directed by a valve.

89. The mobile apparatus of claim 81, wherein the thermal management system controls the flow through at least one of the cooling/heating circuits from the sub-frame to the main frame and vice versa through a swivel joint, optionally through two swivel joints, one for the colder circuit and one for the heated and thus hotter circuit at higher ambient temperatures.

90. The mobile apparatus of claim 81, wherein the thermal system set of valves are controlled by the control system, wherein the hotter components provide heat to the components which require heating.

91. The mobile apparatus of claim 81, wherein the thermal system set of valves are controlled by the control system, wherein the hydraulic circuit(s) provide(s) heat via the set of valves to the cabin and/or batteries or capacitors and/or other components.

92. The mobile apparatus of claim 81, wherein the thermal system set of valves are controlled by the control system, wherein the chiller provides cold fluid to the cabin and optionally to the batteries or capacitors and further to other components such as inverters and electrical motors and chargers in both the sub-frame and the main-frame.

93. The mobile apparatus of claim 81, wherein the thermal system set of valves are controlled by the control system and wherein the cooling/heating circuit to the cabin also cools or heats at least one of the controllers and/or ECUs, optionally at least one of the controllers positioned in the cabin.

94. A mobile apparatus, comprising:
a main-frame with displacing means configured to displace the mobile apparatus;
a rotating sub-frame rotatably connected to the main-frame, such that the sub-frame is rotatable relative to the main frame; and
a working arm connected to the sub-frame,
wherein the main-frame and/or the sub-frame comprises a plurality of modules wherein each module comprises at least one of an energy storage means configured for storing energy, an energy transformation means for transforming energy to electrical energy and a power train means for driving the displacing means; and
wherein the modules are connectable through any one of a high voltage, low voltage or bus control system or a combination thereof and wherein the modules are removably mountable; wherein a module comprising the power train comprises of two electrical motors, of which each of the electrical motors are connected to one axle or carrier of differential via a transmission and a third electrical motor connected to a power take off shaft for attachments via a transmission, optionally the transmissions for the axles or carriers of differentials positioned on the opposite side of the electrical motor with a through shaft in the electrical motors.

95. The mobile apparatus of claim 94, wherein at least one hydraulic pump (2005) is positioned in between one electrical motor and the transmission for the power take off shaft.

96. The mobile apparatus of claim 94, wherein two electrical motors with each one transmission are configured to drive the displacement means and at the same time the power take off shaft, wherein a first electrical motor is connected to a first transmission and that same transmission is connected to at least one hydraulic pump and wherein that same transmission is connected to a second transmission with a second electrical motor through connection or propel shaft, whereby the second transmission provides power from both electrical motors to the displacement means, and whereby both electrical motors provide power to the power take off shaft for attachments.

97. The mobile apparatus of claim 94, wherein a transmission operates at multiple speeds, and optionally comprises a differential, a differential lock, a disconnect and a power take of shaft, optionally with two transmission working together to increase power, torque and speed to displacement means, power take off shaft for attachments and to at least one hydraulic pump.
